(19) United States
(12) Patent Application Publication
(10) Pub. No.: US 2026/0107274 A1
(43) Pub. Date: Apr. 16, 2026

(54) COVERAGE ENHANCEMENT OF PHYSICAL UPLINK CONTROL CHANNEL (PUCCH) TRANSMISSIONS

(71) Applicant: Apple Inc., Cupertino, CA (US)

(72) Inventors: Chunhai YAO, Beijing (CN); Ankit BHAMRI, Bad Nauheim (DE); Chunxuan YE, San Diego, CA (US); Dawei ZHANG, Saratoga, CA (US); Wei ZENG, Saratoga, CA (US); Hong HE, San Jose, CA (US); Haitong SUN, Cupertino, CA (US); Huaning NIU, San Jose, CA (US); Weidong YANG, San Diego, CA (US); Oghenekome OTERI, San Diego, CA (US)

(73) Assignee: Apple Inc., Cupertino, CA (US)

(21) Appl. No.: 19/114,910

(22) PCT Filed: Sep. 29, 2022
(86) PCT No.: PCT/CN2022/122846

§ 371 Date: Mar. 25, 2025

(51) Int. Cl. H04W 72/21; H04L 1/1812; H04W 74/0836

(52) U.S. Cl. CPC H04W 72/21; H04L 1/1812; H04W 74/0836

(57) ABSTRACT

Mechanisms are provided for a user equipment (UE) and a base station to support coverage enhancement of Physical Uplink Control Channel (PUCCH) transmissions by multiple repetitions to improve signal quality and reliability. A UE can be configured to determine, based on a reference signal measurement by the UE and a predetermined threshold, whether the UE is in a repetition enhancement mode to transmit a PUCCH transmission in a dedicated PUCCH resource set in a wireless system. In response to a determination of the UE in the repetition enhancement mode, the UE can transmit the PUCCH transmission in repetitions in the dedicated resource set according to a repetition enhancement configuration, which can be determined based on a system information (SI) received from the base station.

### FIELD

The described aspects generally relate to a wireless communication system, including coverage enhancement of Physical Uplink Control Channel (PUCCH) transmissions in a wireless communication system.

### RELATED ART

A wireless communication system can include a fifth generation (5G) system, a New Radio (NR) system, a long term evolution (LTE) system, a non-terrestrial wireless network (NTN), a combination thereof, or some other wireless systems. In addition, a wireless communication system can support a wide range of use cases such as enhanced mobile broad band (eMBB), massive machine type communications (mMTC), ultrareliable and low-latency communications (URLLC), enhanced vehicle to anything communications (eV2X), among others. Coverage enhancement for signal quality and reliability may be desired for many wireless communication systems.

### SUMMARY

Some aspects of this disclosure relate to apparatuses and methods for implementing techniques for a user equipment (UE) and a base station to support coverage enhancement of Physical Uplink Control Channel (PUCCH) transmissions by multiple repetitions to improve signal quality and reliability. The implemented techniques can be applicable to many wireless systems, e.g., a wireless communication system based on 3rd Generation Partnership Project (3GPP) release 15 (Rel-15), release 16 (Rel-16), release 17 (Rel-17), non-terrestrial wireless networks (NTN), or other wireless networks.

Some aspects of this disclosure relate to operations performed by a UE. The operations performed by a UE can include determining, based on a system information (SI) received from the base station, a repetition enhancement configuration. In some embodiments, the SI can include a system information block 1 (SIB1) message or a system information block 19 (SIB19) message. The repetition enhancement configuration can include a repetition type, repetition number candidates, a collision rule, a frequency hopping mode, or a relationship with demodulation reference signals (DMRS) bundling to keep power consistency and phase continuity during multiple slots. The repetition type can include inter-slot repetition, inter mini-slot repetition, or intra-slot repetition. The frequency hopping mode can include a frequency hopping interval determined by the repetition enhancement configuration, and the relationship with DMRS bundling can include a time domain window (TDW) configured based on the repetition enhancement configuration. The relationship with DMRS bundling can further include a duration of the TDW.

In some embodiments, the UE can determine, based on a reference signal measurement by the UE and a predetermined threshold, whether the UE is in a repetition enhancement mode to transmit a PUCCH transmission in a dedicated PUCCH resource set in a wireless system. In some embodiments, the wireless system can be a nonterrestrial networks (NTN) system, and the PUCCH transmission can be through a satellite between the UE and the base station. The PUCCH transmission can be a PUCCH format 0 transmission or a PUCCH format 1 transmission. The reference signal measurement can include a synchronization signal block (SSB) reference signal received power (RSRP) measurement. When the UE determines the reference signal measurement by the UE is below the predetermined threshold, which indicates that the UE may be close to a cell edge of the wireless system, the UE can enter the repetition enhancement mode. In some embodiments, the dedicated PUCCH resource set can include a part of resource sets allocated to a legacy wireless system.

In response to a determination of the UE in the repetition enhancement mode, the UE can transmit the PUCCH transmission in repetitions in the dedicated resource set according to a repetition enhancement configuration. In some embodiments, the PUCCH transmission can include a hybrid automatic repeat-request (HARQ). In some embodiments, the HARQ included in the PUCCH transmission includes a HARQ-ACK for a message 4 of a 4-step random access channel (RACH) or a HARQ-ACK for a message B of a 2-step RACH.

Some aspects of this disclosure relate to a base station including a transceiver configured to communicate with a UE, and a processor communicatively coupled to the transceiver. The processor can be configured to determine a repetition enhancement configuration for the UE to communicate with the base station in a repetition enhancement mode to transmit a PUCCH transmission in a dedicated PUCCH resource set. The processor can be further configured to transmit the repetition enhancement configuration by a SI to the UE, and receive, from the UE, the PUCCH transmission in multiple repetitions in the dedicated PUCCH resource set according to the repetition enhancement configuration. The PUCCH transmission can include a HARQ.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIGS. 1A-1C illustrate a non-terrestrial wireless network (NTN) including a user equipment (UE) and a base station to support coverage enhancement of Physical Uplink Control Channel (PUCCH) transmissions by multiple repetitions, according to some aspects of the disclosure.

FIG. 2 illustrates a block diagram of a UE or a base station including a transceiver and a processor, according to some aspects of the disclosure.

FIGS. 3A-3C illustrate example processes performed by a UE and a base station to support coverage enhancement of PUCCH transmissions by multiple repetitions, according to some aspects of the disclosure.

FIGS. 4A-4B illustrate example processes performed by a UE and a base station to support coverage enhancement of PUCCH transmissions by multiple repetitions, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

With the development of mobile communication networks, for various reasons, some wireless systems, such as fifth-generation (5G) networks or non-terrestrial wireless networks, may have large propagation delay, higher propagation loss, weaker diffraction capability, and limited and shortened coverage. Non-terrestrial wireless networks (NTN) can refer to any network that involves non-terrestrial flying objects. An NTN can include a satellite communication network, a high altitude platform systems (HAPS), an air-to-ground network, a low-altitude unmanned aerial vehicles (UAVs, aka. drones), or any other NTN. Coverage enhancement technology may be needed to address the challenges in NTN or other similar networks with large propagation delay or other problems.

According to some aspects, in a conventional wireless system, uplink (UL) or downlink (DL) transmissions may be designed for a slot, which may be a dynamic scheduling unit or otherwise defined time duration by a communication standard. There is usually no consistency requirement or coordination in different multiple slots. One coverage enhancement technology to address the challenges due to the large propagation delay may coordinate over multiple slots for UL or DL transmissions, such as demodulation reference signal (DMRS) bundling of repeating a same DMRS or a coherent DMRS over multiple slots, multiple physical downlink shared channel (PDSCH) transmissions with repetitions or multiple physical uplink control channel (PUCCH) transmissions with repetitions, and joint channel estimations of multiple PDSCH transmissions. For example, a UE can send the same or coherent DMRS symbols in multiple slots, which may form a time domain window (TDW) that includes multiple physical uplink shared channel (PUSCH) transmissions or PDSCH transmissions. Similarly, a PUCCH transmission can be sent in multiple repetitions to improve the signal quality and reliability in a repetition enhancement mode for coverage enhancement.

In some embodiments, a UE can be configured to determine, based on a reference signal measurement by the UE and a predetermined threshold, whether the UE is in a repetition enhancement mode to transmit a PUCCH transmission in a dedicated PUCCH resource set in a wireless system. In response to a determination of the UE in the repetition enhancement mode, the UE can transmit the PUCCH transmission in repetitions in the dedicated resource set according to a repetition enhancement configuration, which can be determined based on a system information (SI) received from the base station.

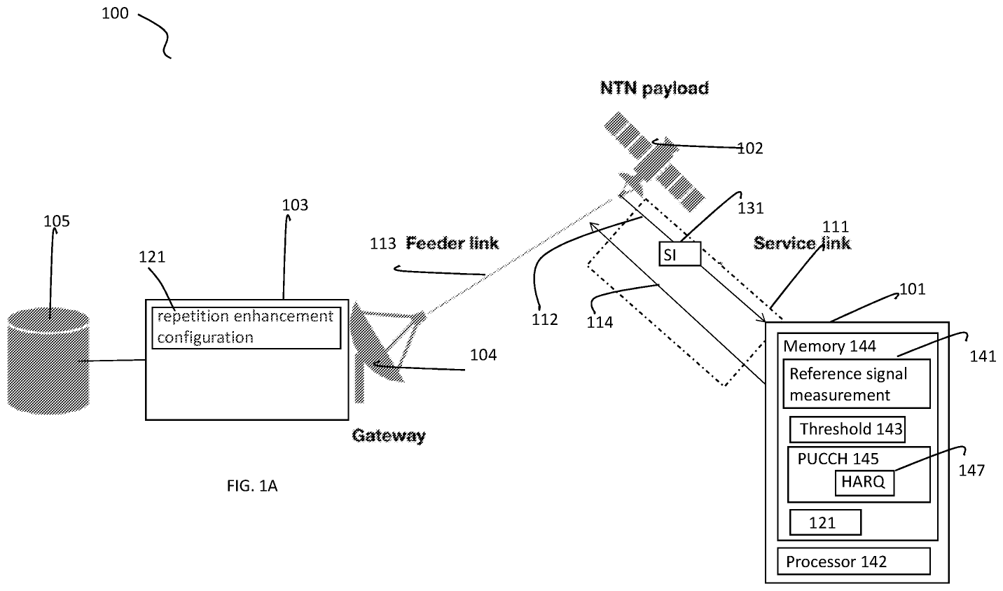

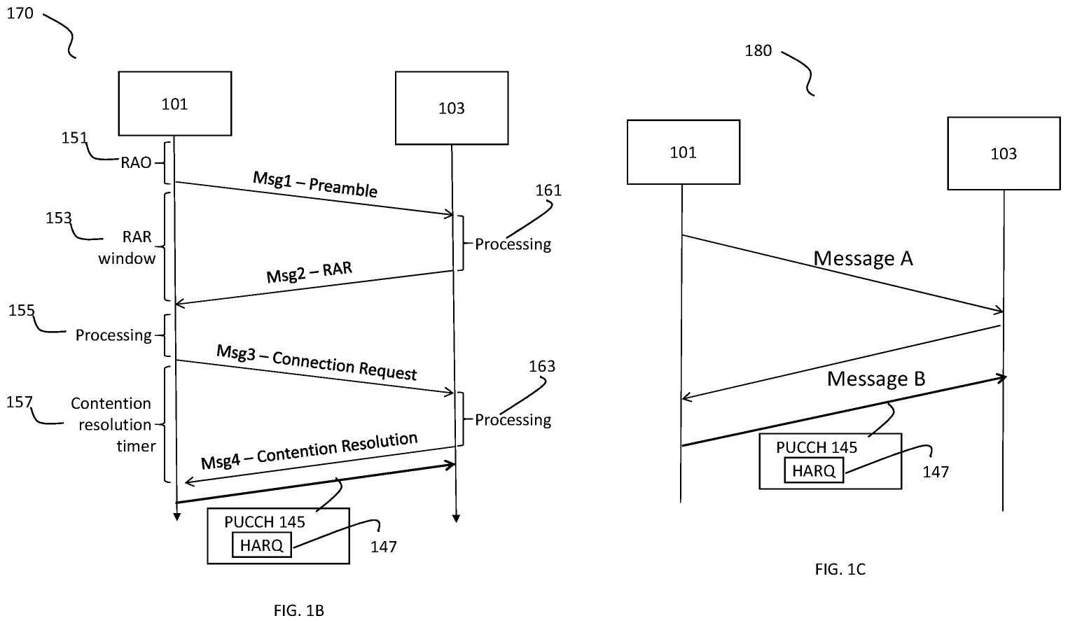

FIG. 1 illustrates an NTN 100 including a UE 101 and a base station 103 to support coverage enhancement of PUCCH transmissions by multiple repetitions, according to some aspects of the disclosure. NTN 100 is provided for the purpose of illustration only and does not limit the disclosed aspects. Techniques described herein for NTN 100 can also be applicable to other wireless systems without a satellite for performing coverage enhancement of PUCCH transmissions by multiple repetitions.

NTN 100 can include, but is not limited to, UE 101, a base station 103, a satellite 102, a gateway 104, and a core network 105. UE 101 communicates with satellite 102 through a service link 111, and satellite 102 communicates with gateway 104 through a feeder link 113. Service link 111 can include a downlink 112 and an uplink 114. Satellite 102 can include a network node or a transceiver for wireless communication. There can be various implementations of NTN 100. For example, base station 103 and gateway 104 may be integrated into one unit instead of being separated components. Base station 103 and core network 105 may implement functions as a normal terrestrial wireless network without a satellite, while gateway 104 may implementation functions between a terrestrial wireless network and satellite 102.

In some embodiments, NTN 100 can have a transparent payload, where base station 103 is located on the ground. In some embodiments, NTN 100 can have a regenerative payload when base station 103 can be located on satellite 102. There can be multiple satellites with onboard base stations communicating with each other. There can be other network entities, e.g., network controller, a relay station, not shown. An NTN can be referred to as a wireless network, a wireless communication system, or some other names known to a person having ordinary skill in the art.

In some embodiments, NTN 100 can be an NTN having a non-terrestrial flying object, e.g., satellite 102. In some embodiments, NTN 100 can include a satellite communication network that includes satellite 102, a HAPS, or an air-to-ground network, or a UAV. There can be multiple satellites in NTN 100. Satellite 102 can be a low Earth orbiting (LEO) satellite, a medium Earth orbiting (MEO) satellite, or a geosynchronous (GSO) Earth orbiting (GEO) satellite. NTN 100 can be a HAPS, which can be an airborne platform including airplanes, balloons, and airships. For example, NTN 100 can include the International Mobile Telecommunications base stations, known as HIBS. A HIBS system can provides mobile service in the same transmission frequency used by terrestrial mobile networks. NTN 100 can be an air-to-ground network to provide inflight connectivity for airplanes by utilizing ground stations which play a similar role as base stations in terrestrial mobile networks. NTN 100 can also be a mobile enabled low-altitude UAVs.

In some embodiments, satellite 102 can be a GEO satellite deployed at an altitude of 35786 Km and is characterized by a slow motion around its orbital position with respect to a point on the Earth. Compared to terrestrial cellular systems, communication networks based on a GEO satellite have a large propagation delay that has to be taken into account in the overall design of the satellite network and high propagation losses. Additionally and alternatively, satellite 102 can be a LEO satellite at an altitude of 300-3000 km. In some embodiments, satellite 102 can communicate with UE 101 over various bands, such as 1610-1618.725 MHz UL (L-band) and 2483.5-2500 MHz DL (S-band). There can be power flux density (PFD) limitation on S-band. For example, for S-band 2483.5-2500 MHz DL for mobile-satellite services, a GSO satellite 102 can have a PFD: P=−146 dB (W/m²) in 4 kHz and −128 dB (W/m²) in 1 MHz, with r=0.5. In addition, a non-GSO satellite 102 can have a PFD: P=−144 dB (W/m²) in 4 kHz and −126 dB (W/m²) in 1 MHz, with r=0.65.

According to some aspects, base station 103 can be a fixed station or a mobile station. In some embodiments, base station 103 can be located onboard satellite 102. Base station 103 can also be called other names, such as a base transceiver system (BTS), an access point (AP), a transmission/reception point (TRP), an evolved NodeB (CNB), a next generation node B (gNB), a 5G node B (NB), or some other equivalent terminology.

According to some aspects, UE 101 can be stationary or mobile. UE 101 can include a processor 142 and a memory 144. UE 101 can be a handheld terminal or a very small aperture terminal (VSAT) that is equipped with parabolic antennas and typically mounted on buildings or vehicles. UE 101 can be a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

In some embodiments, base station 103 can determine a repetition enhancement configuration 121 for UE 101 to transmit in a repetition enhancement mode a PUCCH transmission 145 in a dedicated PUCCH resource set to base station 103, where PUCCH transmission 145 can be a PUCCH format 0 transmission or a PUCCH format 1 transmission, and can be a PUCCH transmission through satellite 102 between UE 101 and base station 103. UE 101 can receive a system information (SI) 131 from base station 103, where SI 131 can include repetition enhancement configuration 121, and store repetition enhancement configuration 121 into memory 144. SI 131 can include a system information block 1 (SIB1) message or a system information block 19 (SIB19) message. UE 101 can perform and obtain a reference signal measurement 141, and determine, based on reference signal measurement 141 and a predetermined threshold 143, whether UE 101 is in a repetition enhancement mode to transmit PUCCH transmission 145 in a dedicated PUCCH resource set, where signal measurement 141 and predetermined threshold 143 can be stored in memory 144. Reference signal measurement 141 can include a synchronization signal block (SSB) reference signal received power (RSRP) measurement. In response to a determination that UE 101 is in the repetition enhancement mode, UE 101 can transmit PUCCH transmission 145 in repetitions in the dedicated resource set according to repetition enhancement configuration 121, wherein PUCCH transmission 145 can include a hybrid automatic repeat-request (HARQ) 147, both of which can be stored in memory 144.

In some embodiments, as shown in FIGS. 1B and 1C, HARQ 147 included in PUCCH transmission 145 can include a HARQ-ACK for a message 4 of a 4-step random access channel (RACH) process 170 or a HARQ-ACK for a message B of a 2-step RACH process 180. Process 170 or process 180 can be referred to as random access (RA) procedures or RACH procedure as well. NTN 100 can support two types of RA procedures, contention-based and contention-free. FIG. 1B shows a contention-based RA having 4-step message exchange process 170 between UE 101 and BS 103, while FIG. 1C shows a contention-free mechanism using only a 2-step message exchange process 180.

In some embodiments, as shown in FIG. 1B, at a time window 151, UE 101 can allocate a RA opportunity (RAO), which can be derived by the configuration index. When there is a RAO, UE 101 can send a random access preamble in message 1 to base station 103, by using a physical random access channel (PRACH). At time window 161, base station 103 can estimate the round-trip time (RTT) for UE 101 based on the time of arrival (ToA) of the received preamble in Message 1. Base station 103 can utilize the ToA estimate for determining a timing advance (TA) to be applied by UE 101. In some embodiments, UE 101 can determine that UE 101 has a capability to operate in the repetition enhancement mode to transmit the PUCCH transmission in multiple repetitions in the dedicated PUCCH resource set. Accordingly, UE 101 can transmit a dedicated preamble for the UE to the base station in a 4-step random access channel (RACH) procedure or a 2-step RACH procedure to indicate the capability of the UE to operate in the repetition enhancement mode.

Base station 103 can continuously check for preamble reception at a RAO and in case it detects one, base station 103 can respond with a random access response (RAR) known as message 2. The RAR contains the TA parameter, as well as the scheduling information pointing to the radio resources that UE 101 has to utilize for subsequent uplink data transmission and the modulation and coding scheme (MCS). UE 101 receives message 2 during a time window 153, and further processes message 2 at time window 155.

UE 101 can transmit message 3 to initiate a connection request where UE 101 is introduced in the network with a unique ID. This phase is also known as the contention resolution phase during time window 163. Afterwards, base station 103 can send back to UE 101 physical downlink shared channel (PDSCH) message 4 including the confirmation regarding the selected temporary identification, which will act as a permanent ID for the user for all the future message exchanges. Similar to message 2 reception, also in this case UE 101 will wait for message 4 during time window 157 until the contention resolution timer is valid. If this timer expires, UE 101 can re-attempt the RA procedure again at another RAO. Hybrid automatic repeat request (HARQ) protocol is adopted for messages 3 and 4 transmission, where PUCCH transmission 145 including HARQ 147 is transmitted from UE 101 to base station 103. HARQ 147 can include an extra message indicating the reception or not (ACK or NACK) of a certain packet. In case of NACK, the same packet has to be retransmitted.

In some embodiments, in case of a contention-free RA procedure as shown in FIG. 1C, message 3 and message 4 transmissions of FIG. 1B are skipped because in such situations the user is already uniquely identified. Accordingly, as shown in FIG. 1C, message A and PDSCH message B are transmitted between UE 101 and base station 103, which are similar to Message 1 and Message 2 of FIG. 1B.

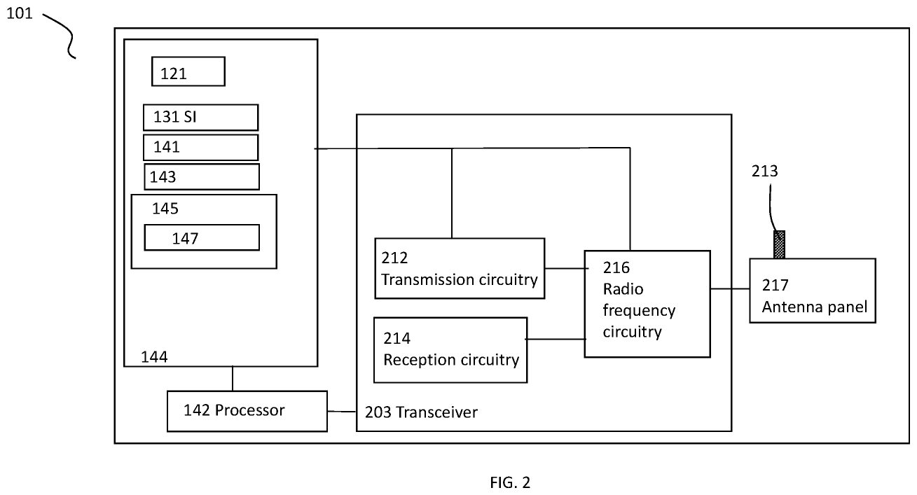

According to some aspects, UE 101 can be implemented according to a block diagram as illustrated in FIG. 2. Base station 103 can also be implemented similarly. Referring to FIG. 2. UE 101 can have antenna panel 217 including one or more antenna elements to form various transmission beams, e.g., transmission beam 213, coupled to a transceiver 203 and controlled by processor 142. Transceiver 203 and antenna panel 217 (using transmission beam 213) can be configured to enable wireless communication in a wireless network, such as supporting satellite communications as shown in NTN 100. In detail, transceiver 203 can include radio frequency (RF) circuitry 216, transmission circuitry 212, and reception circuitry 214. RF circuitry 216 can include multiple parallel RF chains for one or more of transmit or receive functions, each connected to one or more antenna elements of the antenna panel. In addition, processor 142 can be communicatively coupled to memory 144, which are further coupled to the transceiver 203. Various data can be stored in memory 144, such as repetition enhancement configuration 121, reference signal measurement 141, predetermined threshold 143, PUCCH transmission 145, and HARQ 147, as shown in FIG. 1A and FIG. 2.

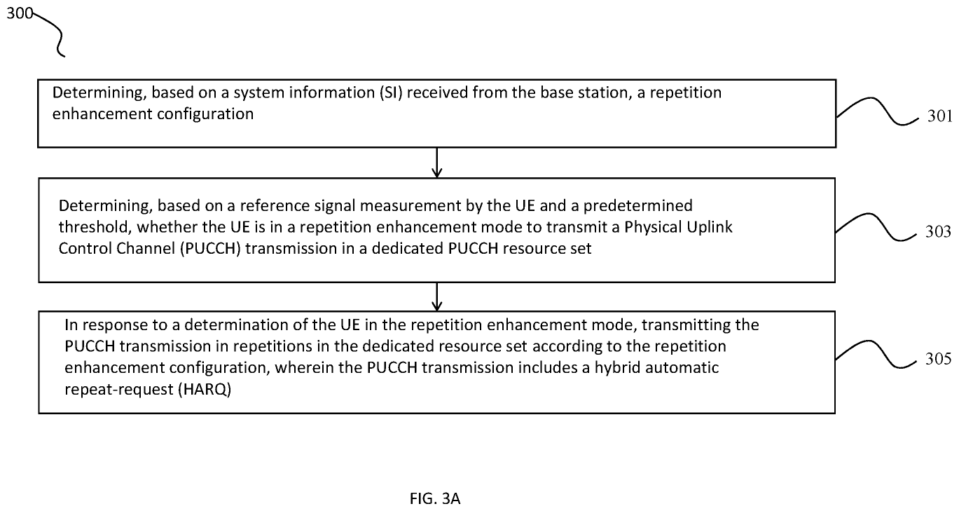

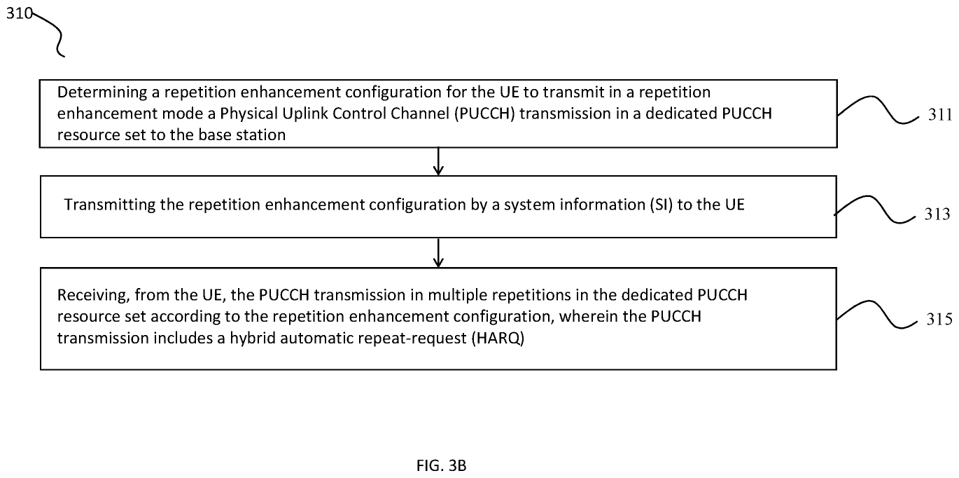

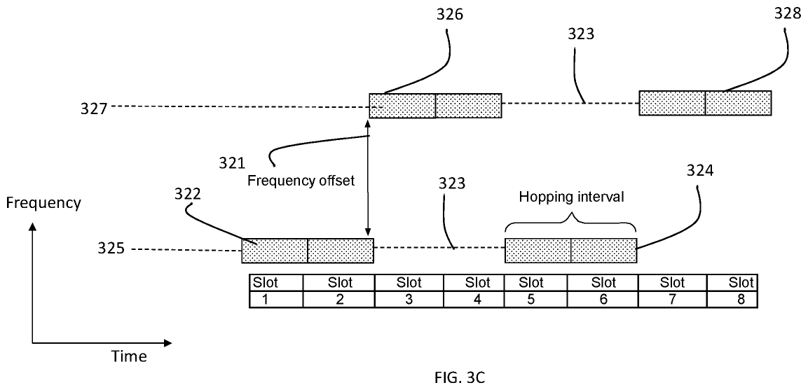

In some embodiments, memory 144 can store instructions, that when executed by processor 142 perform or cause to perform operations described herein, e.g., operations for supporting coverage enhancement of PUCCH transmissions by multiple repetitions to improve signal quality and reliability. Alternatively, processor 142 can be “hard-coded” to perform the operations described herein. In some embodiments, processor 142 can be configured to perform operations described in process 300 in FIG. 3A and process 310 in FIG. 3B.

FIG. 3A illustrates an example process 300 performed by a UE for coverage enhancement of PUCCH transmissions by multiple repetitions, according to some aspects of the disclosure. Similarly, FIG. 3B illustrates an example process 310 performed by a base station for coverage enhancement of PUCCH transmissions by multiple repetitions, according to some aspects of the disclosure. According to some aspects, as shown in FIGS. 3A-3B, process 300 can be performed by UE 101, and process 310 can be performed by base station 103.

At 301. UE 101 can determine, based on SI 131 received from base station 103, repetition enhancement configuration 121. In some embodiments, SI 131 can include a system information block 1 (SIB1) message or a system information block 19 (SIB19) message. Repetition enhancement configuration 121 can include various information, such as a repetition type, repetition number candidates, a collision rule, a frequency hopping mode, or a relationship with demodulation reference signals (DMRS) bundling to keep power consistency and phase continuity during multiple slots. In some embodiments, the repetition type can include an inter-slot repetition, inter mini-slot repetition, or intra-slot repetition. The frequency hopping mode can include a frequency hopping interval determined by repetition enhancement configuration 121, and the relationship with DMRS bundling can include a time domain window (TDW) configured based on repetition enhancement configuration 121. In some embodiments, the relationship with DMRS bundling further includes a duration of the TDW.

In some embodiments, SI 131 can be a SIB1 (or SIB19) message that includes repetition enhancement configuration 121 to indicate NTN 100 supporting coverage enhancement for PUCCH transmissions 145 including HARQ-ACK 147 in response to message 4 of a RACH procedure as shown in FIG. 1B. The repetition type can be an inter-slot repetition, inter mini-slot repetition, or intra-slot repetition. Repetition enhancement configuration 121 can further include frequency hopping pattern indication, DMRS bundling indication, time domain window size, and more.

In some embodiments, SI 131 can be a SIB1 message to configure the repetition type as an inter-slot repetition, inter mini-slot, or intra-slot repetition, e.g., by configuring the parameter pucch-configcommon. The SIB1 message can also configure the repetition number, such as a repetition number selected from {1, 2, 4, 8, 16}. In some embodiments, for PUCCH resource index 0-6, e.g., PUCCH format 0 with 2 symbols or PUCCH format 1 with 4 symbols, the intra-slot repetition can be supported in second and following slots. In some embodiments, if the PUCCH repetition in a slot collides with a sounding reference signal (SRS), the collision can be resolved based on a priority rule. If the PUCCH repetition collides with a PUSCH transmission in a slot, the existing multiplexing rule can be reused. In some embodiments, for inter-slot repetition, for PUCCH resource index 7-15, only the inter-slot PUCCH repetition may be supported.

In some embodiments, repetition enhancement configuration 121 may indicate that the PUCCH frequency hopping can be supported. A SIB1 message or a SIB 19 message can configure which frequency hopping mode is applied, e.g., by the parameter pucch-configcommon. In some embodiments, inter mini-slot frequency hopping can be supported for PUCCH transmission of format 0 or format 1, with 4 symbols repetition. In some embodiments, inter-slot frequency hopping can be supported for PUCCH format 1 repetition.

In some embodiments, as shown in FIG. 3C, inter-slot frequency hopping can be supported for PUCCH transmission with a hopping interval. A PUCCH transmission and its repetition can include PUCCH transmission 322, PUCCH transmission 324, PUCCH transmission 326, and PUCCH transmission 328. PUCCH transmission 322 and PUCCH transmission 324 can be transmitted at a first frequency band 325, and PUCCH transmission 326 and PUCCH transmission 328 can be transmitted at a second frequency band 327, where the second frequency band 327 is separated from the first frequency band 325 by a frequency offset 321. PUCCH transmission 322 and PUCCH transmission 324 can be separated by a frequency hopping interval (e.g. time interval) 323, so are PUCCH transmission 326 and PUCCH transmission 328. Frequency hopping interval 323 can be configured by base station 103. In some embodiments, the frequency hopping pattern can be specified based on relative slot index and system frame number together.

In some embodiments, repetition enhancement configuration 121 can configure the relationship with DMRS bundling with inter-slot frequency hopping mode. Base station 103 can configure the frequency hopping interval and TDW. Based on repetition enhancement configuration 121, UE 101 can determine the hopping intervals first, then configured TDW, followed by actual TDW. In some embodiments, inter-slot frequency hopping pattern for PUCCH repetitions with DMRS bundling can be determined based on relative slot index. Relative slot 0 can be the slot where PUCCH repetition starts, then following slot index increase by one. In some embodiments, a SIB1 message or SIB19 message can configure PUCCH repetition with DMRS bundling, e.g., by the parameter pucch-configcommon. A default maximum duration of the TDW can be defined, where the maximum duration is the UE capability to keep the power consistency and phase continuity during the DMRS bundling. In some embodiments, TDW can be configured with a number of slot. In some other embodiments, TDW can be configured with a number of mini-slot.

At 303, UE 101 can determine, based on reference signal measurement 141 by UE 101 and the predetermined threshold 143, whether UE 101 is in a repetition enhancement mode to transmit PUCCH transmission 145 in a dedicated PUCCH resource set. In some embodiments, reference signal measurement 141 can include a SSB RSRP measurement. When UE 101 determines that reference signal measurement 141 is below the predetermined threshold 143, UE 101 can be in the repetition enhancement mode to transmit PUCCH transmission 145 in a dedicated PUCCH resource set. In some embodiments, when reference signal measurement 141 is below the predetermined threshold 143, UE 101 may be close to a cell edge of NTN 100.

In some embodiments, the reference signal measurement 141 and the predetermined threshold 143 are related to SSB RSRP, which can determine the PUCCH coverage enhancement. The predetermined threshold 143 may be indicated in a SIB1 message or SIB19 message. In some embodiments, UE 101 can report its capability to operate in a repetition enhancement mode to support the coverage enhancement. Separate PRACH occasion or separate PRACH preambles in case of shared PRACH occasions are allocated for NTN UEs. If a dedicated preamble is detected by base station 103 for UE 101, PUCCH coverage enhancement is supported by UE 101. In some embodiments, the preambles can be further divided into several sub-groups, each preamble sub-group is associated with repetition, frequency hopping, DMRS bundling respectively. In some embodiments, UE capability on supporting PUCCH coverage enhancement for message 4 can include the following components, PUCCH format 0 and PUCCH format 1 repetition, inter mini-slot repetition and/or inter-slot repetition, frequency hopping mode, inter minislot frequency hopping, inter slot frequency hopping, inter-slot frequency hopping with hopping interval, DMRS bundling with inter-slot frequency hopping. DMRS bundling for PUCCH format 1.

In some embodiments, the dedicated PUCCH resource set can be a part of resource sets allocated to a legacy wireless system. The existing PUCCH resource sets before dedicated PUCCH resource configuration in Table 9.2.1-1 of TS38.213, shown below, can be re-used. A different entry can be configured for a legacy UE and a NTN coverage enhancement UE, e.g., the legacy UE is configured with index 0, and the NTN UE can be configured with index 2 of Table 9.2.1-1.

TABLE 9.2.1-1
PUCCH resource sets before dedicated PUCCH resource configuration

| | PUCCH | First | Number of | PRB offset | Set of initial |
|---|---|---|---|---|---|
| Index | format | symbol | symbols | ${RB}_{BWP}^{offset}$ | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

In some embodiments, new PUCCH resources can be defined as the dedicated resource set for transmitting the PUCCH transmission in repetitions according to the repetition enhancement configuration. New PUCCH resources are PUCCH resources not reused or allocated to a legacy wireless system. Table 1 shows a new PUCCH resource table. In Table 1, the PUCCH format can still be format 0 and format 1. In some embodiments, new PUCCH resources may be defined only for PUCCH format 1. For index 0-2, the starting symbol can be symbol 0, 2, 4, 6, 8, 10, or 12. Starting from symbol 0 can be beneficial for inter mini-slot repetition. For index 3-6, the starting symbol can be 0, 4, 8. For index 11-15, the starting symbol can be 0.

At 305, in response to a determination that UE 101 is in the repetition enhancement mode, UE 101 can transmit PUCCH transmission 145 in repetitions in the dedicated resource set according to repetition enhancement configuration 121, where PUCCH transmission 145 can include HARQ 147.

TABLE 1

| | PUCCH | First | Number of | | Set of initial |
|---|---|---|---|---|---|
| Index | format | symbol | symbols | PRB offset | CS indexes |
| 0 | 0 | 0 | 2 | 1 | {0, 3} |
| 1 | 0 | 0 | 2 | 1 | {0, 4, 8} |
| 2 | 0 | 0 | 2 | 4 | {0, 4, 8} |
| 3 | 1 | 0 | 4 | 1 | {0, 6} |
| 4 | 1 | 0 | 4 | 1 | {0, 3, 6, 9} |
| 5 | 1 | 0 | 4 | 3 | {0, 3, 6, 9} |
| 6 | 1 | 0 | 4 | 5 | {0, 3, 6, 9} |
| 7 | 1 | 0 | 10 | 1 | {0, 6} |
| 8 | 1 | 0 | 10 | 1 | {0, 3, 6, 9} |
| 9 | 1 | 0 | 10 | 3 | {0, 3, 6, 9} |
| 10 | 1 | 0 | 10 | 5 | {0, 3, 6, 9} |
| 11 | 1 | 0 | 14 | 1 | {0, 6} |
| 12 | 1 | 0 | 14 | 1 | {0, 3, 6, 9} |
| 13 | 1 | 0 | 14 | 3 | {0, 3, 6, 9} |
| 14 | 1 | 0 | 14 | 5 | {0, 3, 6, 9} |
| 15 | 1 | 0 | 14 | Floor of | {0, 3, 6, 9} |
| | | | | (BWT size/5) | |

In some embodiments, PUCCH transmission 145 can include HARQ 147 and can be sent in response to message B, as shown in FIG. 1C. In some embodiments, separate PRACH occasion or separate PRACH preambles in case of shared PRACH occasions can be allocated for NTN UEs for 2-step RACH process. If dedicated preamble is detected by base station 103, base station is aware that PUCCH coverage enhancement is supported by UE 101. The predetermined threshold 143 for the SSB RSRP measurement 141 can be determined for 2-step RACH process for NTN UE PUCCH coverage enhancement. The PUCCH resource can be indicated by PUCCH Resource Indicator field in successRAR shown in Table 2 below. A SIB1 message can configure the PUCCH repetition type, DMRS bundling and frequency hopping pattern for message B HARQ-ACK feedback.

TABLE 2

| 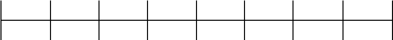 | | | | |
|---|---|---|---|---|
| UE Contention Resolution Identity | | | | Oct. 1 |
| UE Contention Resolution Identity | | | | Oct. 2 |
| UE Contention Resolution Identity | | | | Oct. 3 |
| UE Contention Resolution Identity | | | | Oct. 4 |
| UE Contention Resolution Identity | | | | Oct. 5 |
| UE Contention Resolution Identity | | | | Oct. 6 |
| R | Channel | TPC | HARQ Feedback | Oct. 7 |
| | Access-CPext | | Timing Indicator | |

| | | |
|---|---|---|
| PUCCH Resource | Timing Advance | Oct. 8 |
| Indicator | Command | |

| | |
|---|---|
| Timing Advance Command | Oct. 9 |
| C-RNTI | Oct. 10 |
| C-RNTI | Oct. 11 |

FIG. 3B illustrates process 310 performed by base station 103 for coverage enhancement of PUCCH transmissions by multiple repetitions, according to some aspects of the disclosure. According to some aspects, process 310 can be performed by base station 103.

At 311, base station 103 can determine a repetition enhancement configuration, e.g., repetition enhancement configuration 121, for UE 101 to transmit in a repetition enhancement mode a PUCCH transmission in a dedicated PUCCH resource set to base station 103. In some embodiments, repetition enhancement configuration 121 can include the following fields:
pucch-ResourceCommonNTN-r18 INTEGER (0 . . . 15) OPTIONAL
pucch-RepetitionNTN-r18 ENUMERATED {neither, inter-mini-slot,inter-slot}
pucch-RepetitionNumberNTN-r18 INTEGER {1,2,4,8,16}
pucch-FrequencyhoppingNTN-r18 ENUMERATED
{neither,inter-mini-slotFH, Inter-slotFH,
   Inter-slotFHwithinterval, DMRSbundlingwith Inter-slotFH}
PUCCH-Frequencyhopping-IntervalNTN-r18 INTEGER {1,2,4,8,16}
PUCCH-TimeDomain WindowLengthNTN-r18 INTEGER {2,4,5,10}

At 313, base station 103 can transmit repetition enhancement configuration 121 in SI 131 to UE 101.

At 315, base station 103 receive, from UE 101, PUCCH transmission 145 in multiple repetitions in the dedicated PUCCH resource set according to repetition enhancement configuration 121, where PUCCH transmission 145 includes HARQ 147.

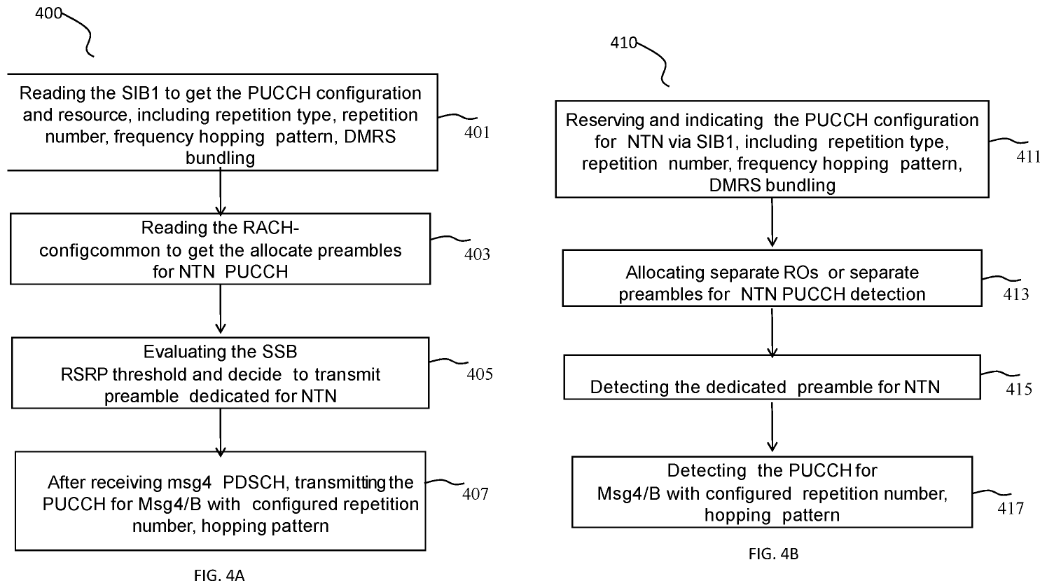

FIGS. 4A-4B illustrate example processes, e.g., process 400 and process 410, performed by a UE and a base station for support coverage enhancement of PUCCH transmissions by multiple repetitions, according to some aspects of the disclosure.

Process 400 shown in FIG. 4A can be an example of process 300 performed by UE 101, illustrated with more, less, or different details.

At 401, UE 101 can read a SIB1 message to get the PUCCH configuration, e.g., repetition enhancement configuration 121, and resource, including a repetition type, repetition number, frequency hopping pattern, and DMRS bundling.

At 403, UE 101 can read the RACH-configcommon to get the allocated preambles for NTN PUCCH.

At 405, UE 101 can evaluate SSB RSRP measurement 141 in comparison with the predetermined threshold 143 and decide to transmit a preamble dedicated for NTN, which can indicate UE 101 is to operate in a repetition enhancement mode.

At 407, after receiving message 4 PDSCH, UE 101 can transmit PUCCH transmission 145 for message 4 or message B with configured repetition number, hopping pattern as determined by repetition enhancement configuration 121.

Process 410 shown in FIG. 4B can be an example of process 310 performed by base station 103, illustrated with more, less, or different details.

At 411, base station 103 can reserve and indicate the PUCCH configuration, e.g., repetition enhancement configuration 121 for NTN via a SIB1 message, where repetition enhancement configuration 121 can include repetition type, repetition number, frequency hopping pattern, DMRS bundling.

At 413, base station 103 can allocate separate ROs or separate preambles for NTN PUCCH detection.

At 415, base station 103 can detect the dedicated preamble for NTN.

At 417, base station 103 can detect the PUCCH for message 4 or message B with configured repetition number, hopping pattern based on repetition enhancement configuration 121.

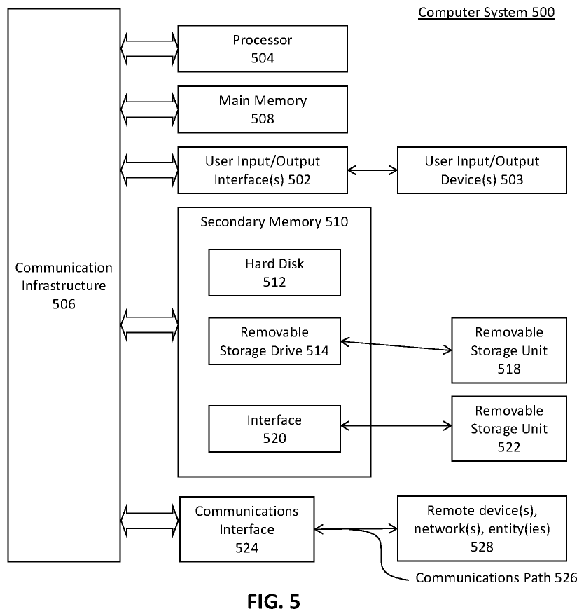

Various aspects can be implemented, for example, using one or more computer systems, such as computer system 500 shown in FIG. 5. Computer system 500 can be any computer capable of performing the functions described herein such as UE 101, or base station 103 as shown in FIGS. 1A-1C and FIG. 2, for operations described for processor 142 or process 300, process 310, processor 400, or process 410 as shown in FIGS. 3A-3B, 4A-4B. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, or base station 103 as shown in FIGS. 1A-1C and FIG. 2. In some examples, the operations include those operations illustrated and described for process 300, process 310, processor 400, or process 410 as shown in FIGS. 3A-3B, 4A-4B.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of performing wireless communication by a user equipment (UE) to a base station in a wireless system, comprising:
determining, based on a system information (SI) received from the base station, a repetition enhancement configuration;
determining, based on a reference signal measurement by the UE and a predetermined threshold, whether the UE is in a repetition enhancement mode to transmit a Physical Uplink Control Channel (PUCCH) transmission in a dedicated PUCCH resource set; and
in response to a determination that the UE is in the repetition enhancement mode, transmitting the PUCCH transmission in repetitions in the dedicated resource set according to the repetition enhancement configuration, wherein the PUCCH transmission includes a hybrid automatic repeat-request (HARQ) feedback.

2. The method of claim 1, wherein the reference signal measurement includes a synchronization signal block (SSB) reference signal received power (RSRP) measurement.

3. The method of claim 1, wherein the SI includes a system information block 1 (SIB1) message or a system information block 19 (SIB19) message.

4. The method of claim 1, wherein the HARQ included in the PUCCH transmission includes a HARQ-ACK for a physical downlink shared channel (PDSCH) message 4 of a 4-step random access channel (RACH) procedure or a HARQ-ACK for a PDSCH message B of a 2-step RACH procedure.

5. The method of claim 1, wherein the PUCCH transmission is a PUCCH format 0 transmission or a PUCCH format 1 transmission.

6. The method of claim 1, wherein the determining the UE is in the repetition enhancement mode comprises determining the reference signal measurement by the UE is below the predetermined threshold, which indicates that the UE is close to a cell edge of the wireless system.

7. The method of claim 1, wherein the wireless system is a non-terrestrial networks (NTN) system, and the PUCCH transmission is through a satellite between the UE and the base station.

8. The method of claim 1, wherein the dedicated PUCCH resource set is configured separately as a part of resource sets predefined for a legacy wireless system.

9. The method of claim 1, wherein the repetition enhancement configuration includes a repetition type, repetition number candidates, a collision rule, a frequency hopping mode, or a relationship with demodulation reference signals (DMRS) bundling to keep power consistency and phase continuity during multiple slots.

10. The method of claim 9, wherein the repetition type includes inter-slot repetition, inter mini-slot repetition, or intra-slot repetition.

11. The method of claim 9, wherein the frequency hopping mode includes a frequency hopping interval determined by the repetition enhancement configuration, and the relationship with DMRS bundling includes a time domain window (TDW) configured based on the repetition enhancement configuration.

12. The method of claim 11, wherein the relationship with DMRS bundling further includes a duration of the TDW.

13. The method of claim 1, further comprising:
determining a capability of the UE to operate in the repetition enhancement mode to transmit the PUCCH transmission in multiple repetitions in the dedicated PUCCH resource set; and
transmitting a dedicated preamble for the UE to the base station in a 4-step random access channel (RACH) procedure or a 2-step RACH procedure to indicate the capability of the UE to operate in the repetition enhancement mode.

14. A base station performing wireless communication in a wireless system, comprising:
a transceiver configured to enable wireless communication with a user equipment (UE); and
a processor communicatively coupled to the transceiver and configured to:
determine a repetition enhancement configuration for the UE to transmit in a repetition enhancement mode a Physical Uplink Control Channel (PUCCH) transmission in a dedicated PUCCH resource set to the base station;
transmit the repetition enhancement configuration in a system information (SI) to the UE; and
receive, from the UE, the PUCCH transmission in multiple repetitions in the dedicated PUCCH resource set according to the repetition enhancement configuration, wherein the PUCCH transmission includes a hybrid automatic repeat-request (HARQ).

15. The base station of claim 13, wherein the HARQ included in the PUCCH transmission includes a HARQ-ACK for a message 4 of a 4-step random access channel (RACH) or a HARQ-ACK for a message B of a 2-step RACH.

16. The base station of claim 13, wherein the repetition enhancement configuration includes a repetition type, repetition number candidates, a collision rule, a frequency hopping mode, or a relationship with demodulation reference signals (DMRS) bundling to keep power consistency and phase continuity during multiple slots.

17. The base station of claim 16, wherein the repetition type includes inter-slot repetition, inter mini-slot repetition, or intra-slot repetition.

18. The base station of claim 16, wherein the frequency hopping mode includes a frequency hopping interval determined by the repetition enhancement configuration, and the relationship with DMRS bundling includes a time domain window (TDW) configured based on the repetition enhancement configuration.

19. A non-transitory computer-readable medium storing instructions that, when executed by a processor of a user equipment (UE), cause the UE to perform operations, the operations comprising:
determining, based on a system information (SI) received from the base station, a repetition enhancement configuration;
determining, based on a reference signal measurement by the UE and a predetermined threshold, whether the UE is in a repetition enhancement mode to transmit a Physical Uplink Control Channel (PUCCH) transmission in a dedicated PUCCH resource set; and
in response to a determination that the UE is in the repetition enhancement mode, transmitting the PUCCH transmission in repetitions in the dedicated resource set according to the repetition enhancement configuration, wherein the PUCCH transmission includes a hybrid automatic repeat-request (HARQ).

20. The non-transitory computer-readable medium of claim 19, wherein the HARQ included in the PUCCH transmission includes a HARQ-ACK for a message 4 of a 4-step random access channel (RACH) or a HARQ-ACK for a message B of a 2-step RACH.
